(19) United States
(12) Patent Application Publication
(10) Pub. No.: US 2024/0019984 A1
(43) Pub. Date: Jan. 18, 2024

(54) CONTROL SYSTEM, CONTROL METHOD, AND RECORDING MEDIUM RECORDING CONTROL PROGRAM

(71) Applicant: SHARP KABUSHIKI KAISHA, Sakai City (JP)

(72) Inventor: YUUKI IWAMOTO, Sakai City (JP)

(21) Appl. No.: 18/218,031

(22) Filed: Jul. 4, 2023

(30) Foreign Application Priority Data
Jul. 13, 2022 (JP) 2022-112298

(51) Int. Cl. G06F 3/04817; G06F 3/0486; G06F 21/62; G06F 21/36

(52) U.S. Cl. CPC G06F 3/04817; G06F 3/0486; G06F 21/629; G06F 21/36

(57) ABSTRACT

A control system includes a reception processing unit that receives an operation of moving a user icon in a virtual space performed by a user corresponding to the user icon, an acquisition processing unit that acquires a position of the user icon in the virtual space, and a permission processing unit that permits a user operation performed by the user on a virtual device installed in the virtual space when the user icon is included in a specific area in the virtual space.

### INCORPORATION BY REFERENCE

This application is based upon and claims the benefit of priority from the corresponding Japanese Patent Application No. 2022-112298 filed on Jul. 13, 2022, the entire contents of which are incorporated herein by reference.

### BACKGROUND

The present disclosure relates to a control system, a control method, and a recording medium recording a control program, for controlling user operations performed on a virtual device in a virtual space.

In general, systems are known that allow certain users to talk to each other when a user icon is moved closer to another user icon in a virtual space or when a user icon is moved to a meeting area.

Here, a user may operate a device icon (a virtual device) installed in a virtual space. For example, the user displays information on a display screen of a virtual display device installed in the virtual space, or inputs information on the display screen. In such a case, for example, information may leak when operation authority is granted to all users in the virtual space. Furthermore, there arises a problem in that convenience is degraded when the operation authority is made stricter.

### SUMMARY

Accordingly, the present disclosure provides a control system, a control method, and a recording medium recording a control program, which can improve convenience while ensuring security when a virtual device is operated in a virtual space.

According to an aspect of the present disclosure, a control system includes a reception processing unit, an acquisition processing unit, and a permission processing unit. The reception processing unit receives an operation of moving a user icon in a virtual space performed by a user corresponding to the user icon. The acquisition processing unit acquires a position of the user icon in the virtual space. The permission processing unit permits a user operation performed by the user on a virtual device installed in the virtual space when the user icon is included in a specific area in the virtual space.

According to another aspect of the present disclosure, a control method causes one or more processors to execute receiving an operation of moving a user icon in a virtual space performed by a user corresponding to the user icon, acquiring a position of the user icon in the virtual space, and permitting a user operation performed by the user on a virtual device installed in the virtual space when the user icon is included in a specific area in the virtual space.

According to a further aspect of the present disclosure, a non-transitory computer-readable recording medium recording a control program that causes one or more processors to execute receiving an operation of moving a user icon in a virtual space performed by a user corresponding to the user icon, acquiring a position of the user icon in the virtual space, and permitting a user operation performed by the user on a virtual device installed in the virtual space when the user icon is included in a specific area in the virtual space.

According to the present disclosure, a control system, a control method, and a recording medium recording a control program, that can improve convenience while ensuring security when a virtual device is operated in a virtual space, may be provided.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram schematically illustrating a configuration of a meeting system according to an embodiment of the present disclosure.

FIG. 2 is a functional block diagram illustrating the configuration of the meeting system according to the embodiment of the disclosure.

FIG. 3 is a diagram illustrating an example of a meeting information management table according to the embodiment of the present disclosure.

FIG. 4 is a diagram illustrating an example of a user information management table according to the embodiment of the present disclosure.

FIG. 5 is a diagram illustrating an example of a meeting-room information management table according to the embodiment of the present disclosure.

FIG. 6 is a diagram illustrating an example of a meeting screen displayed on a user terminal according to the embodiment of the disclosure.

FIG. 7 is a diagram illustrating an example of display of a user icon according to the embodiment of the present disclosure.

FIG. 8 is a diagram illustrating an example of the meeting screen displayed on the user terminal according to the embodiment of the disclosure.

FIG. 9 is a diagram illustrating an example of the meeting screen displayed on the user terminal according to the embodiment of the disclosure.

FIG. 10 is a diagram illustrating an example of the meeting screen displayed on the user terminal according to the embodiment of the disclosure.

FIG. 11 is a diagram illustrating an example of a display screen of a display device according to the embodiment of the present disclosure.

FIG. 12 is a flowchart illustrating an example of a procedure of a meeting control process executed in the meeting system according to the embodiment of the present disclosure.

### DETAILED DESCRIPTION

Hereinafter, an embodiment of the present disclosure will be described below with reference to the accompanying drawings. The following embodiment is an example in which the present disclosure is embodied, and does not limit the technical scope of the present disclosure.

In a control system according to the present disclosure, user icons are moved to a specific area (e.g., a virtual meeting room) set in a virtual space so that users corresponding to the user icons in the specific area may have conversations. Furthermore, in the control system, user operations performed on a virtual device (such as a virtual display) installed in the virtual space are controlled. Furthermore, in the control system, an operation of a device (such as a display) installed in a specific area in a real space (a real meeting room) is controlled. A description will be made below while a meeting system is taken as an example of a control system according to the present disclosure in the following embodiment.

The meeting system may be employed in a web meeting (an online meeting) attended by a plurality of users in different locations (a meeting room of an office, a home, etc.). Furthermore, in the meeting system, a web meeting may be performed between a user participating in the meeting in an office meeting room and a user participating in the meeting at home, for example. Each of the users uses a user terminal, such as a laptop personal computer or a smartphone. Furthermore, a display device including a display for displaying meeting materials to be used in the meeting is installed in the meeting room. Moreover, the meeting system includes a meeting server that provides a web meeting service by means of a meeting application, which is a general-purpose software for executing the web meeting, a management server that provides a management service for managing the web meeting, and a schedule management server that manages schedules of users, such as meeting schedules.

Meeting System 100

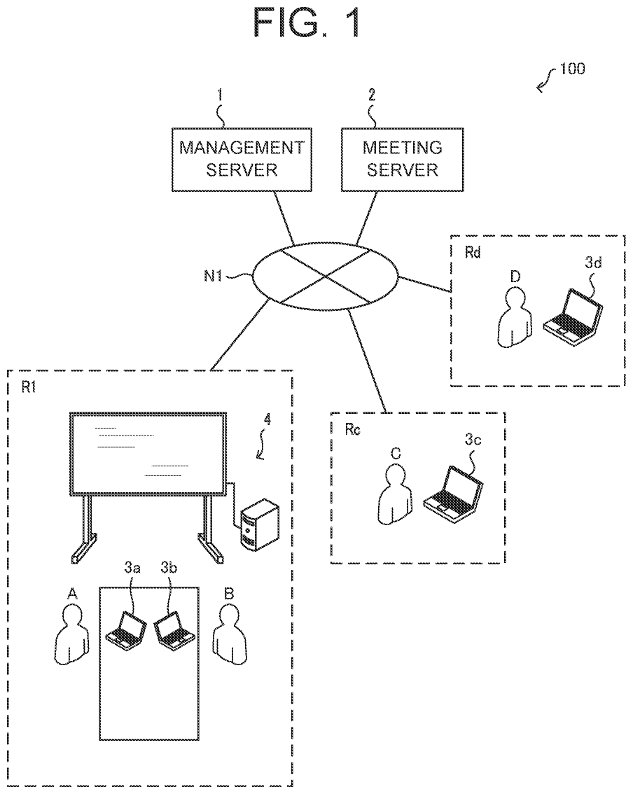

FIG. 1 is a diagram schematically illustrating a configuration of a meeting system 100 according to an embodiment of the present disclosure. The meeting system 100 includes a management server 1, a meeting server 2, a user terminal 3, and a display device 4. In FIG. 1, a schedule management server is omitted. The meeting system 100 supports a web meeting attended by a plurality of users.

In FIG. 1, an office meeting room R1, a home Rc of a user C, and a home Rd of a user D are illustrated. In FIG. 1, an example in which users A and B participate in a meeting in the meeting room R1, the user C participates in the meeting at home Rc, the user D participates in the meeting at home Rd, and the web meeting is performed among the users A to D while the meeting room R1 and the homes Rc and Rd are connected to one another is illustrated. In the meeting room R1, two user terminals 3a and 3b owned by the users A and B, respectively, and a display device 4 including a display (an operation display 43) capable of displaying meeting materials and the like are installed. A user terminal 3c owned by the user C is installed at home Rc, and a user terminal 3d owned by the user D is installed at home Rd. Contents of the display of the display device 4 may be shared on display screens of the user terminals 3a to 3d.

The meeting system 100 enables a web meeting in the meeting room R1, the home Rc, and the home Rd by executing the meeting application installed in the user terminal 3 and the display device 4. The meeting application is a general-purpose software, and the plurality of users participating in the same meeting select the common meeting application to perform the web meeting.

Furthermore, the meeting system 100 can manage the web meeting by executing the meeting management application installed in the user terminal 3 and the display device 4. The meeting management application manages at least one of the following information (meeting management information): a start time of a web meeting, an end time of the web meeting, a period of time elapsed since the web meeting is started, and a remaining time until the end time.

For example, the user A, who is an organizer of the meeting, activates the meeting application on the display device 4 installed in the meeting room R1 and also activates the meeting application on the user terminal 3a of the user A. Furthermore, the users B to D, who are participants in the meeting, activate the meeting application on the user terminals 3b to 3d, respectively, of the users B to D.

Note that, in the meeting system 100, a microphone-speaker device and a camera which are capable of being connected to the user terminal 3 are connected to the user terminal 3 in each of the locations (the meeting room and the homes), so that bidirectional communication of audio and camera images is enabled. The microphone-speaker device and the camera may be incorporated in the user terminal 3.

Each of the management server 1, the meeting server 2, and the schedule management server (not illustrated) is constituted by a single device or a plurality of server devices (e.g., cloud servers).

The management server 1, the meeting server 2, the user terminal 3, the display device 4, and the schedule management server are connected to one another via a network N1. The network N1 is a communication network, such as the Internet, a LAN, a WAN, or a public telephone line. Furthermore, the user terminals 3a and 3b and the display device 4 are connected to one another through a wired LAN or a wireless LAN in the meeting room R1.

The schedule management server is a server device that provides a schedule management service by executing a known schedule management application installed in the user terminal 3. The user can register meeting information and other information related to the web meeting by activating the schedule management application in the user terminal 3. Note that the user can register meeting information and other information related to the web meeting by activating the meeting application installed in the user terminal 3. Specifically, the meeting application may perform data communication with the schedule management server. The schedule management server stores the meeting schedule (meeting reservation information) regarding the meeting information. Identification information (a schedule ID) of a schedule and information on a meeting name and a meeting holding date and time are registered in the meeting schedule.

Meeting Server 2

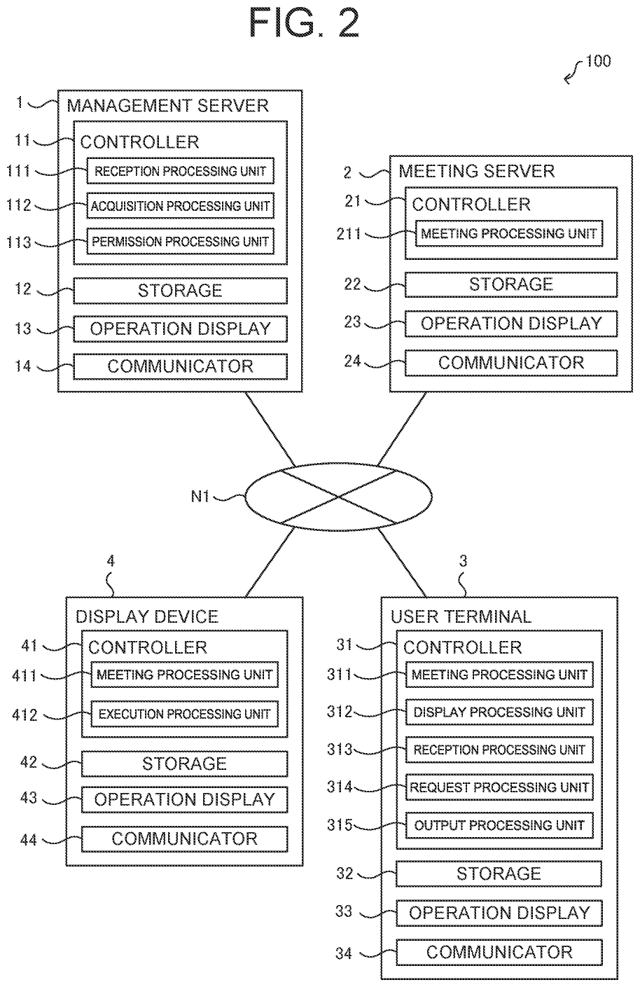

As illustrated in FIG. 2, the meeting server 2 includes a controller 21, a storage 22, an operation display 23, and a communicator 24. The meeting server 2 may be one or a plurality of virtual servers (cloud servers) or may be one or a plurality of physical servers.

The communicator 24 is used to connect the meeting server 2 to the network N1 in a wired or wireless manner, and executes data communication with other devices (such as the management server 1, the user terminal 3, the display device 4, and the schedule management server) in accordance with a predetermined communication protocol through the network N1.

The operation display 23 is a user interface including a display, such as a liquid crystal display or an organic EL display, which displays various types of information, and an operation acceptor, such as a mouse, a keyboard, or a touch panel, which accepts an operation.

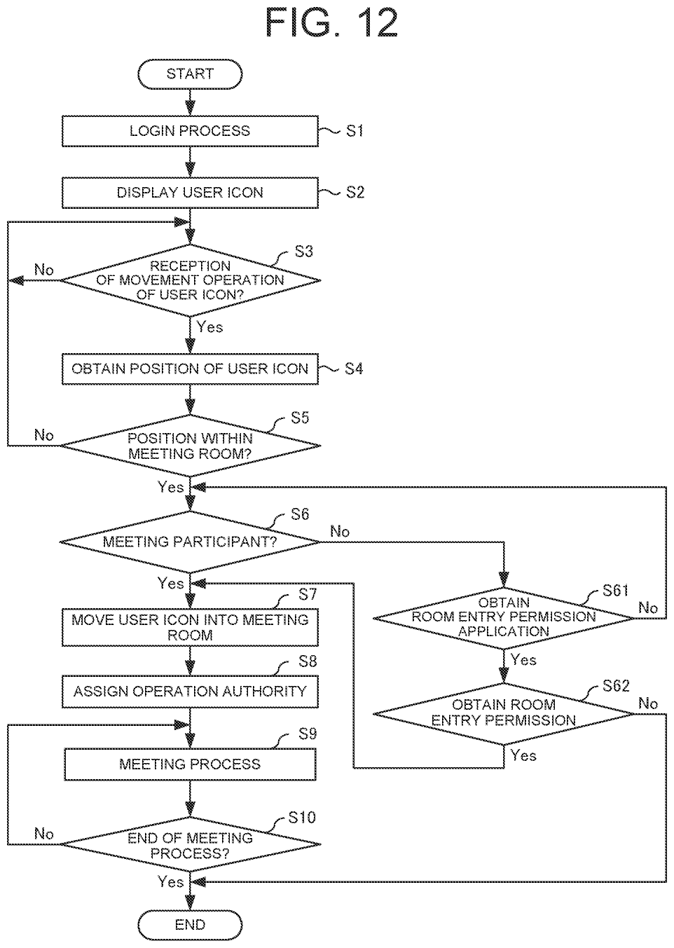

The storage 22 is a non-volatile storage, such as a hard disk drive (HDD), a solid state drive (SSD), or a flash memory, which stores various types of information. The storage 22 stores control programs, such as a meeting program for causing the controller 21 to execute a meeting control process (refer to FIG. 12) described below. For example, the meeting program is recorded in a computer-readable recording medium, such as a CD or a DVD, in a non-transitory manner and may be read by a reading device (not illustrated), such as a CD drive or a DVD drive included in the meeting server 2, so as to be stored in the storage 22. The meeting program may be distributed from a cloud server and stored in the storage 22.

Furthermore, the storage 22 stores a web meeting program for executing a web meeting service. The web meeting program executes the web meeting in response to an execution of the meeting application installed in the user terminal 3. The meeting server 2 of this embodiment provides a web meeting service of the meeting application, which is a general-purpose software application.

User information (such as a user ID and a password) relating to a user who can utilize the meeting application is stored in the storage 22.

In addition, the storage 22 stores meeting information regarding an outline of a web meeting to be held by the user. For example, the user A, the organizer of the web meeting, logs into the meeting application on the user terminal 3a of the user A and registers meeting information for the web meeting. The meeting information includes identification information of the web meeting (a meeting ID), a name of the meeting, participants (participant IDs), a date and time of the meeting, and a location of the meeting (a meeting room ID).

The controller 21 includes control devices such as a CPU, a ROM, and a RAM. The CPU is a processor that executes various types of arithmetic processing. The ROM stores in advance a control program, such as a BIOS or an OS, for causing the CPU to execute various types of processing. The RAM stores various types of information and is used as a temporary storage memory (a work area) for the various types of processing executed by the CPU. The controller 21 controls the meeting server 2 by causing the CPU to execute various control programs stored in advance in the ROM or the storage 22.

Specifically, the controller 21 includes various processing units, such as a meeting processing unit 211. Note that the controller 21 executes various processes in accordance with the meeting program so as to function as the various processing units described above. Moreover, some of or all the processing units included in the controller 21 may be configured by an electronic circuit. Note that the meeting program may cause a plurality of processors to function as the various processing units described above.

The meeting processing unit 211 executes the meeting application in the individual user terminals 3 so as to conduct a web meeting. Specifically, the meeting processing unit 211 starts a web meeting in response to a meeting start request obtained from the user terminal 3. For example, when the user A activates the meeting application on the user terminal 3a, the user terminal 3a transmits a meeting start request for the web meeting to the meeting server 2. Note that the user terminal 3a may transmit the meeting start request to the meeting server 2 when, for example, the user A clicks on a meeting URL displayed on the user terminal 3a. The meeting start request includes information, such as the identification information of the web meeting (a meeting ID), a user ID, and identification information of the user terminal 3a (a terminal ID). Specifically, the meeting processing unit 211 starts the web meeting in response to the meeting start request obtained from the user terminal 3.

Furthermore, the meeting processing unit 211 terminates the web meeting in response to a meeting end request obtained from the user terminal 3. For example, when the user A terminates (logs off) the meeting application on the user terminal 3a (terminates the web meeting), the user terminal 3a transmits a meeting end request for the web meeting to the meeting server 2. The meeting end request includes information, such as the meeting ID, the user ID, and the terminal ID. The meeting processing unit 211 terminates the web meeting in response to the meeting end request obtained from the user terminal 3.

The users A to D participating in the web meeting individually perform the operation of starting the web meeting (the meeting start request) and the operation of terminating the web meeting (the meeting end request) using their own user terminals 3a to 3d, respectively.

User Terminal 3

As illustrated in FIG. 2, the user terminal 3 includes a controller 31, a storage 32, an operation display 33, and a communicator 34. The user terminal 3 is, for example, an information processing apparatus, such as a laptop personal computer, a smartphone, or a tablet device. The user terminals 3a to 3d may have the same functions.

The communicator 34 is used to connect the user terminal 3 to the network N1 in a wired or wireless manner, and executes data communication with other devices (such as the management server 1, the meeting server 2, the display device 4, and the schedule management server) in accordance with the predetermined communication protocol through the network N1. Furthermore, the user terminals 3 is connected to the display device 4 using the communicator 34 through a wired LAN or a wireless LAN in the meeting room R1.

The operation display 33 is a user interface including: a display, such as a liquid crystal display or an organic EL display, which displays various pieces of information; and an operation acceptor, such as a mouse, a keyboard, or a touch panel, which accepts an operation. The operation display 33 accepts a user operation.

The storage 32 is a non-volatile storage, such as an HDD, an SSD, or a flash memory, which stores various types of information. The storage 32 stores control programs, such as a meeting program for causing the controller 31 to execute a meeting control process (refer to FIG. 12) described below. For example, the meeting program is recorded in a computer-readable recording medium, such as a CD or a DVD, in a non-transitory manner, is read by a reader (not shown), such as a CD drive or a DVD drive, included in the user terminal 3, and is stored in the storage 32. Note that the meeting program may be distributed from a cloud server and stored in the storage 32.

Furthermore, one or more meeting applications for providing a web meeting service are installed in the storage 32.

The controller 31 has control devices, such as a CPU, a ROM, and a RAM. The CPU is a processor that executes various types of arithmetic processing. The ROM stores in advance a control program, such as a BIOS or an OS, for causing the CPU to execute various types of processing. The RAM stores various types of information and is used as a temporary storage memory (a work area) for the various types of processing executed by the CPU. The controller 31 controls the user terminal 3 when the CPU executes the various control programs, which are stored in the ROM or the storage 32 in advance. Furthermore, the controller 31 functions as a processing unit that executes the meeting application.

Specifically, the controller 31 includes various processing units, such as a meeting processing unit 311, a display processing unit 312, a reception processing unit 313, a request processing unit 314, and an output processing unit 315. Note that the controller 31 executes various processes in accordance with the control program with the CPU to function as various processing units described above. Furthermore, some of or all the processors included in the controller 31 may be configured by an electronic circuit. Note that the control program may be a program that causes a plurality of processors to function as the various processing units described above.

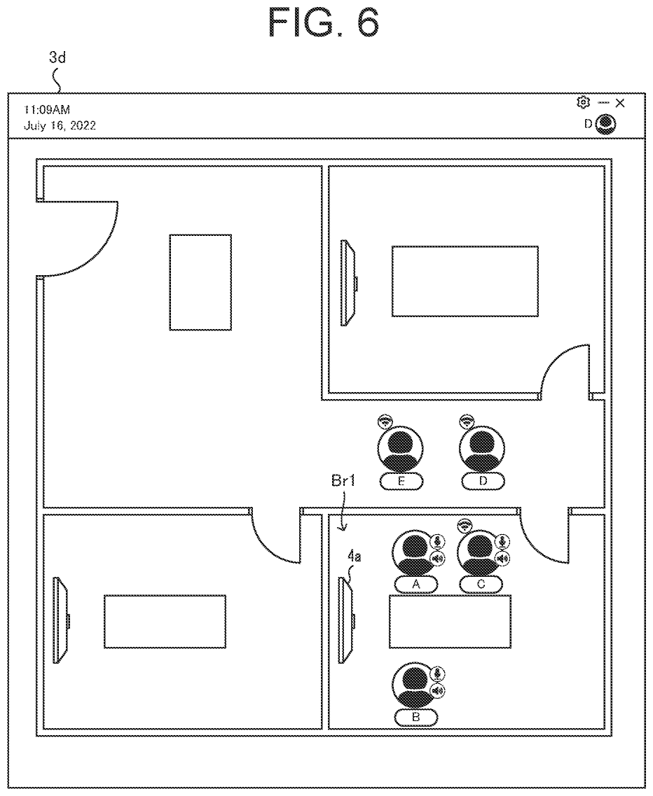

The meeting processing unit 311 executes various processes related to the web meeting in accordance with the meeting application. Specifically, when receiving an operation performed by the user to start the meeting application (a login operation), the meeting processing unit 311 transmits a meeting start request to the meeting server 2. When the meeting server 2 authenticates the meeting start request, the meeting processing unit 311 displays a meeting screen on the user terminal 3 and starts the web meeting. FIG. 6 is a diagram illustrating an example of the meeting screen corresponding to the meeting application (the web meeting service).

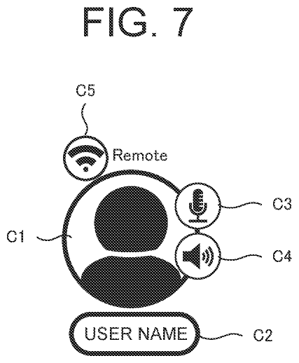

As illustrated in FIG. 6, the display processing unit 312 displays in virtual space a virtual meeting room Br1 corresponding to the meeting room R1 in a real space (refer to FIG. 1) on the meeting screen. Furthermore, the display processing unit 312 also displays user icons that can identify users in the virtual space. FIG. 7 is a diagram illustrating an example of the user icons. The user icon includes a face image C1, such as a photo or illustration of a user, a user name C2, a microphone icon C3 that is displayed when the user logs into the meeting application and can use a microphone, a speaker icon C4 that is displayed when the user logs into the meeting application and can use a speaker, and a remote icon C5 that is displayed when the user logs into the meeting application at a remote location other than the meeting room, such as at home. The display processing unit 312 changes a display mode of the user icon based on a login state and positional information of the user. In the example illustrated in FIG. 6, the users A and B log into the meeting application in the meeting room R1, and users C to E log into the meeting application at remote locations (e.g., home) other than the meeting room R1 (the remote icon C5). Furthermore, the users A to C can use the microphones and the speakers (ON states) and are ready for conversation (the microphone icon C3 and the speaker icon C4).

Furthermore, the display processing unit 312 displays in the virtual space a virtual display 4a corresponding to the display device 4 (refer to FIG. 1) installed in the meeting room R1 in the real space. The virtual display 4a is an example of the virtual device according to the present disclosure.

The display processing unit 312 displays the meeting screen on the operation display 33 in response to an instruction issued from the management server 1. The individual users A to E can view the meeting screen illustrated in FIG. 6 on their own user terminals 3a to 3e, respectively.

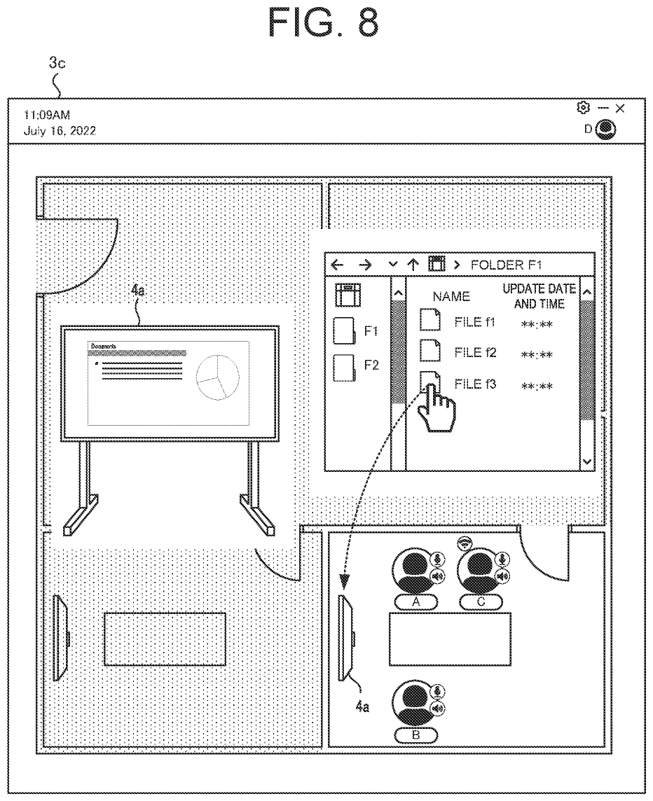

In the state illustrated in FIG. 6, the meeting processing unit 311 transmits and receives audio and videos to and from the user terminals 3a to 3c of the users A to C via the meeting server 2. Furthermore, the display processing unit 312 shares a display screen of the display device 4 among the user terminals 3a to 3c via the meeting server 2. Moreover, the display processing unit 312 displays the display screen of the display device 4 on a display area of the virtual display 4a in the virtual space (refer to FIG. 8). By this, the users A to C can conduct the web meeting.

Furthermore, when receiving an operation performed by the user to terminate the meeting application (the meeting end operation), the meeting processing unit 311 transmits a meeting end request to the meeting server 2. When the meeting server 2 authenticates the meeting end request, the meeting processing unit 311 terminates the web meeting in the user terminal 3. The meeting processing unit 311 is an example of an audio processing unit according to the present disclosure.

Furthermore, the individual users who intend to participate in the web meeting activate the meeting application on their own user terminals 3 to start the web meeting. Moreover, the individual users terminate the meeting application on their own user terminals 3 to terminate the web meeting.

The reception processing unit 313 receives various operations performed by the user. For example, the reception processing unit 313 accepts a user icon movement operation, a file selection-and-display instruction operation, and the like performed by the user in the virtual space included in the meeting screen (refer to FIG. 6) displayed on the operation display 33. Examples of the user operations are described below. The reception processing unit 313 outputs information on the accepted user operation to the management server 1.

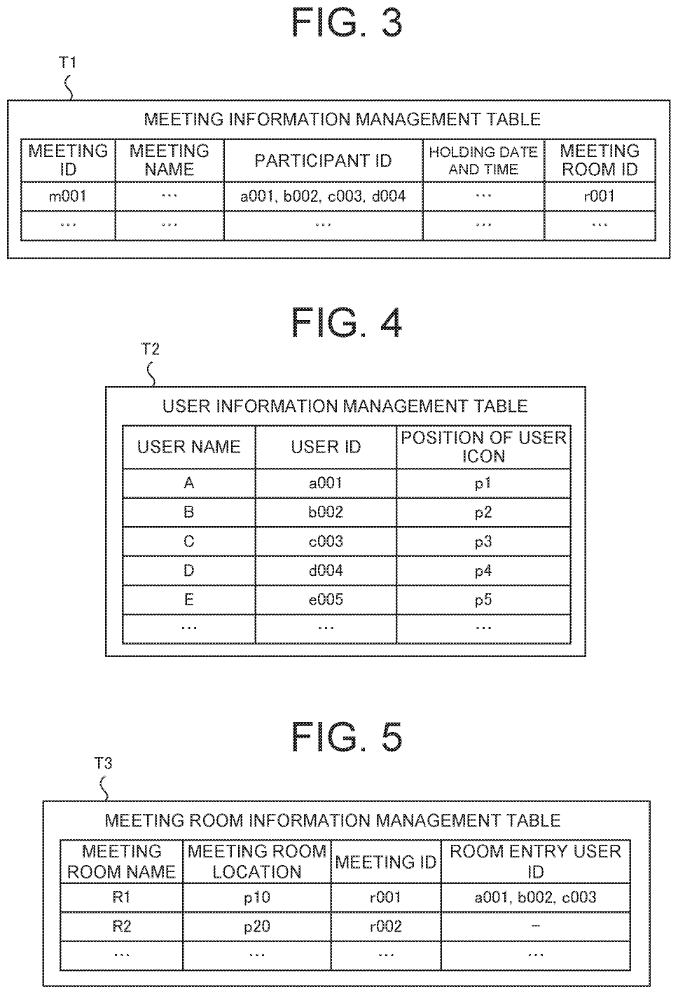

The request processing unit 314 requests the management server 1 for permission to enter the meeting room when a user who is not qualified to participate in the meeting desires to enter the meeting room to participate in the meeting. Specifically, when a user who is not registered in the meeting information (refer to FIG. 3) desires to participate in a meeting by moving a user icon into the virtual meeting room Br1 (room entry) in the virtual space on the meeting screen, the user requests permission to enter the virtual meeting room Br1 in the meeting screen of the user terminal 3. When the reception processing unit 313 accepts the application operation for permission to enter the room that has been performed by the user, the request processing unit 314 outputs the room entry permission application to the management server 1. When obtaining the room entry permission application from the user terminal 3, the management server 1 determines whether to permit the room entry and returns a result of the determination to the user terminal 3 (details are described below).

The output processing unit 315 outputs a display instruction (a display command) to the display device 4 to display information on the operation display 43 of the display device 4 installed in the meeting room R1 in the real space. Specifically, when a user authorized to enter the virtual meeting room Br1 (participate in a meeting) performs an operation to display information in the display area of the virtual display 4a in the virtual space, the output processing unit 315 displays the information on the display device 4 installed in the meeting room R1 (refer to FIG. 11).

Thus, the controller 31 is configured such that a display screen corresponding to a user operation is displayed on the display area of the display device 4 (refer to FIG. 11) and the display area of the virtual display 4a (refer to FIG. 8) installed in the virtual space.

Management Server 1

As illustrated in FIG. 2, the management server 1 includes a controller 11, a storage 12, an operation display 13, and a communicator 14. The management server 1 may be one or a plurality of virtual servers (cloud servers) or may be one or a plurality of physical servers.

The communicator 14 is used to connect the management server 1 to the network N1 in a wired or wireless manner, and executes data communication with other devices (such as the meeting server 2, the user terminal 3, the display device 4, and the schedule management server) in accordance with the predetermined communication protocol through the network N1.

The operation display 13 is a user interface including a display, such as a liquid crystal display or an organic EL display, which displays various types of information, and an operation acceptor, such as a mouse, a keyboard, or a touch panel, which accepts an operation.

The storage 12 is a non-volatile storage, such as an HDD, an SSD, or a flash memory, which stores various types of information. The storage 12 stores control programs, such as a meeting program for causing the controller 11 to execute a meeting control process (refer to FIG. 12) described below. For example, the meeting program is recorded in a computer-readable recording medium, such as a CD or a DVD, in a non-transitory manner, is read by a reader (not shown) such as a CD drive or a DVD drive included in the management server 1, and is stored in the storage 12. Note that the meeting program may be distributed from a cloud server and stored in the storage 12.

In addition, the storage 12 stores a management table including various types of information for managing meetings. Specifically, the storage 12 stores data, such as a meeting information management table T1 that manages meeting information of the web meeting (refer to FIG. 3), a user information management table T2 that manages information on participants of the web meeting (refer to FIG. 4), and a meeting-room information management table T3 that manages information on a meeting room of the web meeting (refer to FIG. 5).

As illustrated in FIG. 3, information (meeting reservation information), such as meeting identification information (a meeting ID), a meeting name, meeting participants (participant IDs), a date and time of the meeting (a start date, an end date, etc.), and meeting-room identification information (a meeting room ID), is registered in the meeting information management table T1. The meeting information management table T1 may be stored in the meeting server 2 or the schedule management server.

As illustrated in FIG. 4, information, such as a user name, a user ID, and a user icon position, is registered in the user information management table T2. The user name and the user ID are used as login information for the meeting application. The user icon position is information indicating a position of a user icon in the virtual space. For example, when the user A logs into the meeting application, the meeting screen is displayed on the user terminal 3a, and the user icon of the user A is displayed in the virtual space of the meeting screen (refer to FIG. 6, etc.). Furthermore, the meeting screen also displays user icons of a plurality of users who have logged in. The meeting screen of the user terminal 3d of the user D is illustrated in FIG. 6, and here, user icons of the individual users A to E are displayed. The controller 11 obtains positions of the user icons in the virtual space and registers the positions in the user information management table T2.

As illustrated in FIG. 5, the meeting-room information management table T3 includes information on a meeting room name, a meeting room location, a meeting room ID, and identification information of users currently in the virtual meeting room Br1 in the virtual space (room-entry user IDs). The controller 11 identifies identification information of the users currently in the virtual meeting room Br1 based on the positional information of the user icons.

Note that some of or all the meeting information management table T1, the user information management table T2, and the meeting-room information management table T3 may be stored in another server.

The controller 11 includes control devices such as a CPU, a ROM, and a RAM. The CPU is a processor that executes various types of arithmetic processing. The ROM stores in advance a control program, such as a BIOS or an OS, for causing the CPU to execute various types of processing. The RAM stores various types of information and is used as a temporary storage memory (a work area) for the various types of processing executed by the CPU. The controller 11 controls the management server 1 by causing the CPU to execute various control programs stored in advance in the ROM or the storage 12.

Specifically, the controller 11 includes various processing units, such as a reception processing unit 111, an acquisition processing unit 112, and a permission processing unit 113. Note that the controller 11 executes various processes in accordance with the meeting program so as to function as the various processing units. Furthermore, some of or all the processing units included in the controller 11 may be configured by an electronic circuit. Note that the meeting program may cause a plurality of processors to function as the various processing units described above.

The controller 11 manages various types of information to manage the meeting. Specifically, the controller 11 obtains meeting reservation information from the schedule management server and registers the meeting reservation information in the meeting information management table T1 (refer to FIG. 3). Furthermore, the controller 11 acquires, based on the registration operation performed by the user, user information (user registration information) relating to the user having use authority of the meeting application, and registers the user information in the user information management table T2 (refer to FIG. 4). Furthermore, based on the registration operation performed by the user, the controller 11 obtains the meeting room information about the meeting room and registers the meeting room information in the meeting-room information management table T3 (refer to FIG. 5).

The reception processing unit 111 receives an operation of moving a user icon in the virtual space performed by the user. For example, on the meeting screen of the user terminal 3d illustrated in FIG. 6, when the user D performs an operation (a drag-and-drop operation) to move the user icon of the user D into the meeting room R1, the reception processing unit 111 receives the movement operation from the user terminal 3d. Note that the reception processing unit 111 may accept the movement operation of the user icon in the virtual space from only the user corresponding to the user icon, or may accept the movement operations of all user icons from a specific user (an administrator).

The acquisition processing unit 112 acquires a position of the user icon in the virtual space. In the example illustrated in FIG. 6, the acquisition processing unit 112 acquires positions of the users A to E in the virtual space. Specifically, the acquisition processing unit 112 acquires positions p1 to p5 of the user icons of the users A to E in the virtual space. Furthermore, the acquisition processing unit 112 acquires the positions specified by the individual users in the virtual space of the meeting screen of the user terminal 3 as the positions of the user icons of the users. Note that the acquisition processing unit 112 may acquire the positions in the virtual space corresponding to the positions (seated positions) of the users A and B in the meeting room R1 (refer to FIG. 1) in the real space as the positions p1 and p2 of the user icons of the users A and B. When acquiring the positions p1 to p5 of the user icons, the acquisition processing unit 112 registers position information in the user information management table T2 (refer to FIG. 4). Furthermore, when the positions of the user icons are within the virtual meeting room Br1 (an example of the specific area in this disclosure) in the virtual space, the acquisition processing unit 112 registers the user IDs of the users corresponding to the user icons in the “room entry user ID” of the meeting-room information management table T3 (refer to FIG. 5).

The permission processing unit 113 permits a user operation on the virtual display 4a, which is located in the virtual space, when the user icon is included in the virtual meeting room Br1 in the virtual space (refer to FIG. 5). The virtual meeting room Br1 is, for example, a room area where the virtual display 4a is installed and where a user icon corresponding to a predetermined user is allowed to enter (room entry).

Specifically, the permission processing unit 113 permits a user operation of the user on the virtual display 4a when the user icon of the user registered in the meeting information (refer to FIG. 3) including a planned use of the virtual meeting room Br1 exists in the virtual meeting room Br1. For example, in the case where the users A to D are registered as meeting participants included in the meeting information of the meeting room R1 (a meeting room ID “r001”) (refer to FIG. 3), the user icons corresponding to the users A to C are located in the virtual meeting room Br1 in the state illustrated in FIG. 6. In this case, for example, when the user C selects a file of meeting materials on the meeting screen displayed on the user terminal 3c (refer to FIG. 8) and moves the file onto the virtual display 4a (a drag-and-drop operation), the permission processing unit 113 permits the user operation and displays the meeting materials in the display area of the virtual display 4a (refer to FIG. 8). In other words, the permission processing unit 113 grants the user located in the virtual meeting room Br1 the authority to operate the virtual display 4a and allows the user to perform a display instruction operation on the virtual display 4a.

Specifically, the permission processing unit 113 prohibits a user operation of the user on the virtual display 4a when the user icon of the user registered in the meeting information (refer to FIG. 3) is out of the virtual meeting room Br1. For example, when the user D is registered as a meeting participant (refer to FIG. 3), but the user icon of the user D is located outside the virtual meeting room Br1 as illustrated in FIG. 6, the permission processing unit 113 prohibits a user operation (the display instruction operation) of the user D on the virtual display 4a. When prohibiting the user operation performed by the user D, the permission processing unit 113 may display information on the user terminal 3d, such as a prompt to move into the virtual meeting room Br1.

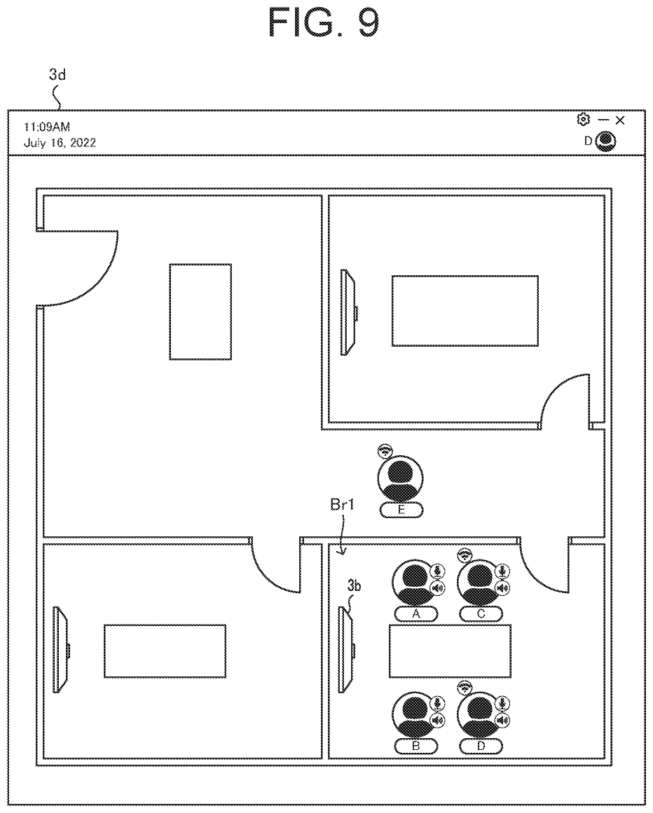

Here, the permission processing unit 113 permits the user icon corresponding to the user D to enter the virtual meeting room Br1 when the user D is registered as a meeting participant in the meeting information. For example, when the user D moves the user icon of the user D into the virtual meeting room Br1 by a drag-and-drop operation on the meeting screen displayed on the user terminal 3d, the permission processing unit 113 permits the movement operation and displays the user icon in the virtual meeting room Br1 (refer to FIG. 9). By this, since the user icon of the user D is positioned in the virtual meeting room Br1, the permission processing unit 113 grants the user D the authority to operate the virtual display 4a and allows the user D to perform the display instruction operation.

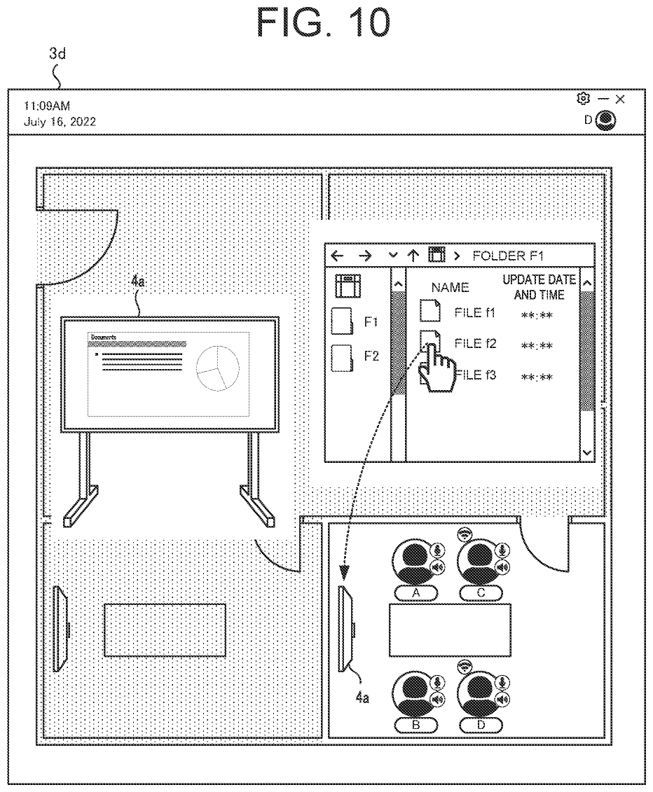

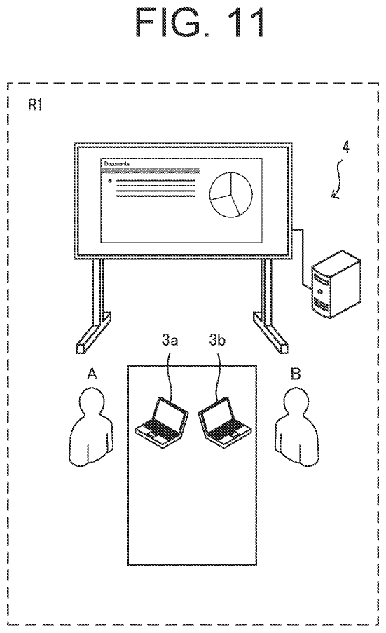

Note that, when the permission processing unit 113 allows a user icon corresponding to a user to enter the virtual meeting room Br1, the meeting processing unit 311 of the user terminal 3 of the user starts a meeting process. The display processing unit 312 of the user terminal 3 displays the microphone icon C3 and the speaker icon C4 in the user icons (refer to FIG. 9). Accordingly, the user D may participate in the web meeting. When the user D is authorized to operate the virtual display 4a, the user D can select meeting materials and display the meeting materials in the display area of the virtual display 4a, for example, as illustrated in FIG. 10.

Furthermore, the permission processing unit 113 prohibits user operations on the virtual display 4a by users not registered in the meeting information (refer to FIG. 3). Moreover, the permission processing unit 113 prohibits room entry to the virtual meeting room Br1 of a user icon corresponding to a user not registered in the meeting information and prohibits user operations of the user on the virtual display 4a. For example, since the user E is not registered as a meeting participant (refer to FIG. 3), the permission processing unit 113 prohibits the user E from room entry to the virtual meeting room Br1 of a user icon of the user E and prohibits user operations of the user E on the virtual display 4a. The permission processing unit 113 may display information on the user terminal 3e to encourage the user E to apply for permission to enter the virtual meeting room Br1 (permission to participate in the meeting) when prohibiting the user icon of the user E from entering the virtual meeting room Br1, or when prohibiting user operations by the user E.

Here, when the user registered in the meeting information allows the user icon corresponding to the user not registered in the meeting information (refer to FIG. 3) to enter the virtual meeting room Br1, the permission processing unit 113 may permit the user icon to enter the virtual meeting room Br1 and permit user operations by the user on the virtual display 4a. For example, the user E, who is not registered in the meeting information, applies for permission to enter the virtual meeting room Br1 on the meeting screen of the user terminal 3e (refer to FIG. 9) when the user E desires to participate in the meeting. When obtaining the application for room entry permission from the user terminal 3e, the permission processing unit 113 transmits information to the user terminal 3a of the user registered in the meeting information (e.g., the organizer, the user A) inquiring whether the user E is allowed to enter the room (participates in the meeting). When the user A enters a response indicating permission to the inquiry, the permission processing unit 113 permits the user E to enter the room (participate in the meeting).

By this, for example, when the user E moves the user icon of the user E into the virtual meeting room Br1 by a drag-and-drop operation on the meeting screen displayed on the user terminal 3e, the permission processing unit 113 permits the movement operation and displays the user icon in the virtual meeting room Br1. Furthermore, when the user icon of the user E is positioned in the virtual meeting room Br1, the permission processing unit 113 permits the display instruction operation by the user E. Accordingly, the user E may participate in the web meeting.

Display Device 4

As illustrated in FIG. 2, the display device 4 includes a controller 41, a storage 42, an operation display 43, and a communicator 44. Here, the display device 4 is installed in the meeting room R1 (refer to FIG. 1) in the real space.

The communicator 44 is used to connect the display device 4 to the network N1 in a wired or wireless manner, and executes data communication with other devices (such as the management server 1, the meeting server 2, the user terminal 3, and the schedule management server) in accordance with the predetermined communication protocol through the network N1. Furthermore, the display device 4 is connected to the user terminals 3a and 3b in the meeting room R1 using the communicator 44 through a wired LAN or a wireless LAN.

The operation display 43 is a user interface including a display, such as a liquid crystal display or an organic EL display, which displays various types of information, and an operation acceptor, such as a mouse, a keyboard, or a touch panel, which accepts an operation.

The storage 42 is a non-volatile storage, such as an HDD, an SSD, or a flash memory, which stores various types of information. The storage 42 stores control programs, such as a meeting program for causing the controller 41 to execute a meeting control process (refer to FIG. 12) described below. For example, the meeting program is recorded in a computer-readable recording medium, such as a CD or a DVD, in a non-transitory manner, is read by a reading device (not illustrated), such as a CD drive or a DVD drive, provided in the display device 4, and is stored in the storage 42. Note that the meeting program may be distributed from a cloud server and stored in the storage 42.

Furthermore, one or more meeting applications for providing a web meeting service are installed in the storage 42.

The controller 41 includes control devices such as a CPU, ROM, and RAM. The CPU is a processor that executes various types of arithmetic processing. The ROM stores in advance a control program, such as a BIOS or an OS, for causing the CPU to execute various types of processing. The RAM stores various types of information and is used as a temporary storage memory (a work area) for the various types of processing executed by the CPU. The controller 41 controls the display device 4 by causing the CPU to execute various control programs stored in advance in the ROM or the storage 42.

Furthermore, the controller 41 functions as a processing unit that individually executes a meeting application and a meeting management application.

Specifically, the controller 41 includes various processing units, such as a meeting processing unit 411 and an execution processing unit 412. Note that the controller 41 executes various processes in accordance with the control program with the CPU to function as various processing units described above. Some of or all the processing devices included in the controller 41 may be configured by an electronic circuit. Note that the control program may be a program that causes a plurality of processors to function as the various processing units described above.

The meeting processing unit 411 executes various processes related to the web meeting in accordance with the meeting application. Specifically, when receiving an operation performed by the user to activate the meeting application, the meeting processing unit 411 transmits a meeting start request to the meeting server 2. When the meeting server 2 authenticates the meeting start request, the meeting processing unit 411 displays a meeting screen on the display device 4 and starts the web meeting.

For example, the meeting processing unit 411 obtains the meeting information (a meeting schedule) associated with the user from the schedule management server and displays the meeting information on the display device 4. When the user selects a desired meeting using the meeting information and presses a start button, the meeting processing unit 411 starts the web meeting corresponding to the meeting.

Furthermore, when receiving an operation performed by the user to terminate the meeting application (the meeting end operation), the meeting processing unit 411 transmits a meeting end request to the meeting server 2. When the meeting server 2 authenticates the meeting end request, the meeting processing unit 411 terminates the web meeting in the display device 4.

The execution processing unit 412 displays information on the operation display 43 based on the display instruction (a display command) output from the user terminal 3. For example, in the virtual meeting room Br1, when a user with the operation authority over the virtual display 4a performs an operation to display meeting materials in the display area of the virtual display 4a, the user terminal 3 outputs the display instruction to be displayed on the operation display 43 of the display device 4 installed in the meeting room R1. The execution processing unit 412 receives the display instruction and executes the display process. Specifically, the execution processing unit 412 displays the meeting materials on the display device 4 in the meeting room R1.

Accordingly, the users A and B who participate in the meeting in the meeting room R1 can view the meeting materials displayed on the display device 4 (refer to FIG. 11), and the users C and D who participate in the meeting at home Rc and at home Rd can view the meeting materials displayed on the virtual display 4a in the virtual space displayed on the user terminals 3c and 3d (refer to FIG. 10).

Meeting Control Process

An example of a procedure of the meeting control process executed by the meeting system 100 will now be described below with reference to FIG. 12.

Note that the present disclosure can be regarded as a meeting control method (an example of a control method of the present disclosure) in which one or more steps included in the meeting control process are executed. Furthermore, the one or more steps included in the meeting control process described herein may be omitted as appropriate. Furthermore, the order in which the steps of the meeting control process are executed may vary as long as the same effect and advantage are produced.

Furthermore, herein, a case is described as an example in which each of the controllers of the management server 1, the meeting server 2, and the user terminal 3 performs a corresponding one of the steps in the meeting control process, but in another embodiment, one or more processors may perform each of the steps in the meeting control process in a distributed manner.

First, in step S1, the controller 21 of the meeting server 2 executes a process of logging into the meeting application. Specifically, when a user activates the meeting application on the user terminal 3 and performs the login operation, the controller 21 executes the login process (an authentication process).

Next, in step S2, the controller 31 of the user terminal 3 displays the meeting screen of the meeting application on the operation display 33, displays the virtual space (the virtual meeting room Br1) of the meeting room R1 (refer to FIG. 1) on the meeting screen, and displays a user icon of a user who has logged in within the virtual meeting room Br1 (refer to FIG. 6). Note that the controller 31 may display the user icon in a predetermined position (a default position) immediately after the login.

Next, in step S3, the controller 31 determines whether an operation of moving the user icon has been received from the user on the meeting screen. When the controller 31 determines that the movement operation has been received from the user (S3: Yes), the controller 31 shifts the process to step S4. The controller 31 waits until the movement operation is received from the user (S3: No).

In step S4, the controller 31 acquires a position of the user icon. Specifically, the controller 31 acquires a position of the user icon in the virtual meeting room Br1 based on the operation of moving the user icon performed by the user on the meeting screen.

Next, in step S5, the controller 31 determines whether the position of the user icon is within the virtual meeting room Br1. When the controller 31 determines that the position of the user icon is within the virtual meeting room Br1 (S5: Yes), the controller 31 shifts the process to step S6. On the other hand, when the controller 31 determines that the position of the user icon is out of the virtual meeting room Br1 (S5: No), the process proceeds to step S3.

In step S6, the controller 11 of the management server 1 determines whether the user whose user icon has been moved into the virtual meeting room Br1 is a meeting participant. Specifically, the controller 11 determines whether the user has been registered as a meeting participant in the meeting information (refer to FIG. 3). When the controller 11 determines that the user is a meeting participant (S6: Yes), the process proceeds to step S7. On the other hand, when the controller 11 determines that the user is not a meeting participant (S6: No), the process proceeds to step S61.

In step S7, the controller 31 of the user terminal 3 moves the user icon into the virtual meeting room Br1. By this, the meeting participant may move the user icon of the meeting participant to the virtual meeting room Br1 in the virtual space.

Here, the controller 31 displays the speaker icon C4 and the remote icon C5 on the user icon that has entered the virtual meeting room Br1 (refer to FIG. 7), and enables transmission and reception of audio and videos of the user through the meeting server 2. By this, users corresponding to a plurality of user icons located in the virtual meeting room Br1 may perform a web meeting.

Next, in step S8, the controller 11 of the management server 1 grants the users corresponding to the user icons located in the virtual meeting room Br1 operation authority of a user operation on the display device 4 (refer to FIG. 1) installed in the meeting room and a user operation on the virtual display 4a installed in the virtual meeting room Br1 corresponding to the display device 4. In the example illustrated in FIG. 6, the controller 11 grants the users A to C operation authority for a display instruction operation to display meeting materials on the display device 4 installed in the meeting room R1 and operation authority for a display instruction operation to display meeting materials on the virtual display 4a installed in the virtual meeting room Br1.

Next, in step S9, the controller 31 of the user terminal 3 executes the meeting process. For example, the controller 31 starts transmission and reception of audio and videos with the user terminals 3 of the users corresponding to the plurality of user icons located in the virtual meeting room Br1. Furthermore, as illustrated in FIG. 8, for example, when the user C selects the meeting materials in the virtual space and moves the meeting materials to the virtual display 4a, the controller 31 displays the meeting materials in the display area of the virtual display 4a and outputs a display instruction (a display command) for displaying the meeting materials on the display device 4 installed in the meeting room R1. The display device 4 displays the meeting materials on the operation display 43 based on the display instruction (refer to FIG. 11).

In step S10, the controller 31 determines whether the meeting process has been terminated. For example, when the meeting participant terminates the web meeting by terminating the meeting application in the user terminal 3, the controller 31 terminates the meeting process. When the meeting is terminated (S10: Yes), the controller 31 terminates the meeting control process. The controller 31 continues to execute the meeting process (S9) until the meeting process is terminated.

When the user of the user icon that is to move into the virtual meeting room Br1 is not a meeting participant (S6: No), in step S61, the controller 31 determines whether an application for permission to enter the virtual meeting room Br1 is obtained from the user. When the controller 31 has obtained the room entry permission application (S61: Yes), the process proceeds to step S62. Meanwhile, when the controller 31 has not obtained the room entry permission application (S61: No), the process returns to step S6. For example, in the example illustrated in FIG. 6, when the user D moves the own user icon into the virtual meeting room Br1 on the user terminal 3d and applies for permission to enter the room, the controller 31 obtains the room entry permission application. When obtaining the room entry permission application, the controller 31 outputs the room entry permission application to the management server 1.

In step S62, the controller 31 determines whether a room entry permission has been obtained for the room-entry application from the management server 1. For example, when the user D has been registered in the meeting information (refer to FIG. 3), the controller 11 of the management server 1 permits entry of the user icon corresponding to the user D into the virtual meeting room Br1, whereas when the user D has not been registered as a meeting participant in the meeting information, the controller 11 prohibits entry of the user icon corresponding to the user D into the virtual meeting room Br1. When the controller 31 has obtained the room entry permission application from the management server 1 (S62: Yes), the process proceeds to step S7. Meanwhile, when the controller 31 has not obtained the room entry permission from the management server 1 (S62: No), the meeting control process is terminated.

As another embodiment, when the user registered in the meeting information allows the user icon corresponding to the user not registered in the meeting information (refer to FIG. 3) to enter the virtual meeting room Br1, the controller 11 of the management server 1 may permit the user icon to enter the virtual meeting room Br1.

As described above, the meeting system 100 executes the meeting control process.

As described above, the meeting system 100 of this embodiment accepts the movement operation of a user icon in the virtual space from the user corresponding to the user icon, acquires a position of the user icon in the virtual space, and permits a user operation on a virtual device (the virtual display 4a) installed in the virtual space when the user icon is included in a specific area in the virtual space (the virtual meeting room).

According to the above configuration, for example, the operation authority for the operation of displaying information in the display area of the virtual display 4a, which is located in the virtual space, can be limited to a specific user, for example, a user corresponding to a user icon located in the specific area (the virtual meeting room) where the virtual display 4a is located. This configuration controls the operation authority of a virtual device in a specific area according to whether a user icon is included in the specific area, and therefore, convenience is improved while security is ensured when the virtual device is operated in the virtual space.

Furthermore, when an operation target device (the display device 4) corresponding to a virtual device (the virtual display 4a) installed in a specific area in the virtual space is installed in a current specific region (the meeting room R1) in the real space, and when a user icon is included in the specific area in the virtual space, the meeting system 100 of this embodiment permits a user operation performed by a user corresponding to the user icon on the operation target device. For example, a user in a remote location where the aforementioned user operation is permitted can display information on the display device 4 installed in the meeting room R1 by performing a display instruction operation on the virtual display 4a in the virtual space.

The present disclosure is not limited to the above-described embodiment. In the embodiment described above, a display device (display) is used as an example of the operation target device in this disclosure. However, the operation target device in the present disclosure is not limited to this and may be, for example, an audio processing device (such as a microphone or a speaker) installed in a meeting room, a multifunction peripheral, a printer, an air conditioner, a lighting device, and the like.

The control system according to the present disclosure may be constituted by the management server 1, the meeting server 2, the user terminal 3, and the display device 4 as illustrated in FIG. 2, or may be constituted by the management server 1 alone or the user terminal 3 alone.

### APPENDIX OF DISCLOSURE

An outline of the disclosure derived from the above embodiments will be described below as an appendix. Note that configurations and processing functions described in the following appendix can be selected to be added or omitted and arbitrarily combined.

### APPENDIX 1

A control system, comprising:
a reception processing circuit that receives an operation of moving a user icon in a virtual space performed by a user corresponding to the user icon;
an acquisition processing circuit that acquires a position of the user icon in the virtual space; and
a permission processing circuit that permits a user operation performed by the user on a virtual device installed in the virtual space when the user icon is included in a specific area in the virtual space.

### APPENDIX 2

The control system according to claim 1, wherein the virtual device is installed in the specific area, and a movement of the user icon corresponding to a predetermined user into the specific area is permitted.

### APPENDIX 3

The control system according to claim 1 or 2, wherein the permission processing circuit permits a user operation performed by a first user on the virtual device, when a first user icon of the first user which is registered in use schedule information including use schedule of the specific area in advance is included in the specific area.

### APPENDIX 4

The control system according to claim 3, wherein the permission processing circuit permits a user operation performed by a second user who is not registered in the use schedule information on the virtual device, when the first user permits a second user icon corresponding to the second user to enter the specific area.

### APPENDIX 5

The control system according to claim 3 or 4, wherein the permission processing circuit prohibits a second user icon corresponding to a second user who is not registered in the use schedule information from entering the specific area and prohibits a user operation performed by the second user on the virtual device.

### APPENDIX 6

The control system according to any one of claims 1 to 5, further comprising an audio processing circuit that transmits and receives audio between user terminals of respective users corresponding to the plurality of user icons included in the specific area.

### APPENDIX 7

The control system according to any one of claims 1 to 6, wherein
an operation target device corresponding to the virtual device installed in the specific area in the virtual space is installed in a current specific area in a real space, and
when the user icon is included in the specific area in the virtual space, the permission processing circuit permits a user operation performed by a user corresponding to the user icon on the operation target device.

### APPENDIX 8

The control system according to claim 7, further comprising:
a display processing circuit that displays the specific area in the virtual space and the user icon on a user terminal of the user, wherein
when the operation target device is a display device, the display processing circuit displays a display screen corresponding to the user operation in a display area of the display device installed in the real space and a display area of a virtual display device installed in the virtual space.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A control system, comprising:
a reception processing circuit that receives an operation of moving a user icon in a virtual space performed by a user corresponding to the user icon;
an acquisition processing circuit that acquires a position of the user icon in the virtual space; and
a permission processing circuit that permits a user operation performed by the user on a virtual device installed in the virtual space when the user icon is included in a specific area in the virtual space.

2. The control system according to claim 1, wherein the virtual device is installed in the specific area, and a movement of the user icon corresponding to a predetermined user into the specific area is permitted.

3. The control system according to claim 2, wherein the permission processing circuit permits a user operation performed by a first user registered in use schedule information including use schedule of the specific area in advance on the virtual device, when a first user icon of the first user is included in the specific area.

4. The control system according to claim 3, wherein the permission processing circuit permits a user operation performed by a second user who is not registered in the use schedule information on the virtual device, when the first user permits a second user icon corresponding to the second user to enter the specific area.

5. The control system according to claim 3, wherein the permission processing circuit prohibits a second user icon corresponding to a second user who is not registered in the use schedule information from entering the specific area and prohibits a user operation performed by the second user on the virtual device.

6. The control system according to claim 1, further comprising an audio processing circuit that transmits and receives audio between user terminals of respective users corresponding to the plurality of user icons included in the specific area.

7. The control system according to claim 1, wherein
an operation target device corresponding to the virtual device installed in the specific area in the virtual space is installed in a current specific area in a real space, and
when the user icon is included in the specific area in the virtual space, the permission processing circuit permits a user operation performed by a user corresponding to the user icon on the operation target device.

8. The control system according to claim 7, further comprising:
a display processing circuit that displays the specific area in the virtual space and the user icon on a user terminal of the user, wherein
when the operation target device is a display device, the display processing circuit displays a display screen corresponding to the user operation in a display area of the display device installed in the real space and a display area of a virtual display device installed in the virtual space.

9. A control method that causes one or more processors to execute:
receiving an operation of moving a user icon in a virtual space performed by a user corresponding to the user icon;
acquiring a position of the user icon in the virtual space; and
permitting a user operation performed by the user on a virtual device installed in the virtual space when the user icon is included in a specific area in the virtual space.

10. A non-transitory computer-readable recording medium recording a control program that causes one or more processors to execute:
receiving an operation of moving a user icon in a virtual space performed by a user corresponding to the user icon;
acquiring a position of the user icon in the virtual space; and
permitting a user operation performed by the user on a virtual device installed in the virtual space when the user icon is included in a specific area in the virtual space.
